(19) United States
(12) Patent Application Publication
(10) Pub. No.: US 2002/0025336 A1
(43) Pub. Date: Feb. 28, 2002

(54) Lice remover composition

(75) Inventors: Thomas M. McGuire, Greenwich, CT (US); Robert D. Kross, Bellmore, NY (US)

Correspondence Address: CHARLES N.J. RUGGIERO, ESQ., OHLANDT, GREELEY, RUGGIERO & PERLE, L.L.P., 10th FLOOR, ONE LANDMARK SQUARE, STAMFORD, CT, 06901-2682, US

(73) Assignee: Care Technologies Inc.

(21) Appl. No.: 09/943,129

(22) Filed: Aug. 30, 2001

Related U.S. Application Data
(63) Continuation of application No. 09/550,142, filed on Apr. 17, 2000.

(51) Int. Cl. A01N 25/00

(52) U.S. Cl. 424/405; 424/400

(57) ABSTRACT

There is provided a surfactant composition that is capable of attacking lipids of the nits. The surfactant is an anionic surfactant.

### BACKGROUND OF THE INVENTION

1. Field of The Invention

The present invention generally relates to a composition for the removal of nits (i.e. lice eggs) from hair. In particular, the present invention relates to surfactant-based compositions. These compositions are capable of attacking the lipids of the substance that binds the nits to hair thereby facilitating the subsequent physical removal of the nits from the hair. Further, the present invention relates to a method of loosening the nits to facilitate the physical removal of the nits from the hair.

2. Description of the Prior Art

Head lice are capable of spreading disease. Specifically, head lice are vectors for staphylococcal skin infections, e.g., impetigo, furunculosis, and are also the principle method of transmission for typhus, trench fever, and relapsing fever.

The head louse (pediculus humanus capititis) infests roughly 2 to 3% of grade school children in the United States and England. The females, about ⅛ inch long, deposit approximately 270 to 300 eggs on the hair. Most commonly, the deposits on the hair are above the ears and the back of the head near the base of the hair shaft. The eggs are cemented to the hair with a tenacious protein-like substance. In order to return to school in many jurisdictions, children must be nit free.

Effective control of head lice can be obtained with a number of insecticides (termed pediculicides for this application), such as malathion, carbaryl, lindane, pyrethrins and piperonyl butoxide, and the synthetic pyrethrin analog permethrin. The most acceptable treatments involve products that contain the pediculicide, some of which are prescription products (e.g., lindane). Some eggs, however, reportedly survive these treatments. This was explicitly cited by the FDA in its monograph covering pyrethrum based pediculicides which included a package label requirement that a second treatment was required “in 7 to 10 days to kill any newly hatched lice” from the surviving eggs.

Physical removal of the lice can be accomplished to a significant degree with hair washing followed by thorough brushing. Fine toothed nit combs, which are designed for removal of the nits anchored to the hair shaft, are not particularly effective in removing and killing all eggs. If still alive, the eggs can hatch and lead to a full reinfestation of the hair. If dead, following pediculicide treatment, they can still represent a social embarrassment for both child and parent, with no absolute certainty that the nits are all dead and therefore potentially reinfesting.

Therefore, efforts have recently been directed to develop products that are effective in unlocking the bond between the lice egg and the hair. One such product is marketed under the trademark STEP 2® by GenDerm as a lice egg removal kit. STEP 2® is a liquid treatment that attempts to loosen the bond between lice eggs and hair to facilitate nit removal via a fine tooth comb. STEP 2® has a formic acid base that is a harsh chemical and produces an unpleasant odor. It also contains a polyquaternium conditioner, and benzyl alcohol and cetyl alcohol as preservatives.

Not Nice To Lice product by RC International, the RID® product by Pfizer, and the Clear product by the assignee of the present invention, are enzyme based compositions having other ingredients, the compositions of which are directed to assist in the removal of head lice and their eggs.

There was a study of the molecular composition of the louse sheath by Burkhart et al. in The Journal of Parasitology, June 1999, vol. 85, No. 3, 560). The study showed that the macromolecular structure of the human louse nit sheath is mainly composed of protein, with specific composition dominated by aromatic amino acid, perhaps associated with lipids, i.e. fatty acid derivatives.

Unlike the above lice-removing products, the present invention does not necessarily contain any enzymes. However, it satisfactorily and gently facilitates the removal of lice eggs from hair strands. It is normally used in conjunction with a pediculicide treatment. The pediculicide treatment, as described above, kills live lice and some of the nits on the host. However, the present compositions that are surfactant-based are capable of attacking the lipids of the nit, thereby facilitating the subsequent physical removal of a substantial number of lice nits from the hair. The present surfactant-based compositions are effective in solubilizing the lipids in nit glue, and causing swelling of the glue. Therefore the surfactant-based compositions serve to complete treatment and facilitate the clearance of all nits, and particularly presence of viable nits on the host following the pediculicide treatment.

### SUMMARY OF THE INVENTION

It is an object of the present invention to provide a nit removal composition.

It is another object of the present invention to provide such a nit removal composition that has an ingredient that is capable of attacking the lipids of the nit.

It is still another object of the present invention to provide such a nit removal composition that has a surfactant as the primary active ingredient.

It is yet another object of the present invention to provide an embodiment of the nit removal composition that may include one or more, organic acids, thickeners, preservatives, solvents, colors, enzymes and mixtures thereof.

It is a further object of the present invention to provide a method for loosening nits on the hair and thereby facilitate the removal of the nits from the hair. The hair may be human hair, specifically hair from the head of a human or hair from the pubic region of a human.

It is still a further object of the present invention to provide such a method that comprises the application of a surfactant-based composition to the hair.

These and other objects of the present invention are achieved by a nit removal composition that includes a surfactant as the primary, and in one embodiment, the only active ingredient.

Preferably, the enzyme-based composition is applied to the hair prior to, subsequent to, or in conjunction with a pediculicide composition. Moreover, the method may further comprise removing the lice eggs or nits from the hair after they have been dislodged from the hair.

The present invention also provides a method for removing nits from hair, which comprises applying a surfactant-based composition, which is capable of attacking the lipids of the nits, thereby facilitating the dislodging of the nits from the hair.

Other and further objects, advantages and features of the present invention will be understood by reference to the following specification.

### DETAILED DESCRIPTION OF THE INVENTION

The present invention provides compositions, and methods, for removing nits from hair. The composition has a primary active ingredient that is capable of attacking lipids of the nits. While not intending to be bound by this belief, it is believed that the primary active ingredient solubilizes the lipids in nit glue and thereby causes swelling of the glue.

This primary active ingredient is a surfactant. Accordingly, the composition is considered a surfactant-based composition. The surfactant is a surfactant that is capable of attacking the lipids in the nits, and preferably is an anionic surfactant. Such surfactants have been found to be safe to humans. In the preferred embodiment, the anionic surfactant is a lipophilic anionic surfactant.

In a preferred embodiment, the anionic surfactant is a sulfonate or sulfate. The sulfonate is one or more of the following: benzene, toluene, xylene, naphthalene, condensed naphthalene, alkylnaphthalene, dodecyl, tridecyl, petroleum, sulfonates of ethoxylated alkylphenols, and sulfonates of oils and fatty acids. The sulfates are one or more of the following: ethoxylated alkylphenol, sulfates of oils and fatty acids, alcohol, sulfates of ethoxylated alcohols, and sulfates of fatty esters. In a more preferred embodiment, the anionic surfactant is from the class, dodecyl benzene sulfonate (DDBSA), with the more preferred being sodium dodecyl benzene sulfonate.

The surfactant is preferably present in an amount about 0.05 percentage by weight or weight percent (wt %) to about 5 wt % of the total weight of the composition. More preferably, the surfactant is about 0.05 wt % to about 2 wt % of the total weight of the composition. Most preferably, the surfactant is about 0.2 wt % to about 1 wt % of the total weight of the composition.

In the first and all embodiments of the present invention, the composition includes water.

In a second embodiment of the present invention, the composition has, besides the anionic surfactant, an organic acid. The preferred organic acid is a low molecular weight acid, C₁-C₄ acid, or substituted hydroxy derivative thereof. Such organic acids are lactic acid, glycolic acid, and acetic acid.

The organic acid is preferably present in an amount about 0.2 wt % to about 6 wt % of the total weight of the composition. More preferably, the organic acid is preferably present in an amount about 1.0 wt % to about 5.0 wt % of the total weight of the composition.

It other embodiments of the present invention, the present composition includes a thickener. The thickener can be included with the anionic surfactant alone, or the combination of the anionic surfactant and the acid.

The thickener can be anyone or a combination of xanthan gum, methyl cellulose, hydroxypropyl cellulose, hydroxyethyl cellulose, a Carbopol, gum acacia, Sepigel 305, Vee-Gum, magnesium aluminum silicate, a polyoxyethylene, polyacrylamide, and derivatives thereof.

The thickener is preferably present in an amount about 0.1 wt % to about 1 wt % of the total weight of the composition. More preferably, the thickener is present in an amount about 0.2 wt % to about 2 wt % of the total weight of the composition.

It is a further embodiment of the present composition, to also include a preservative to anyone of the above embodiments. The preservative is preferably one or more of the following: disodium EDTA, EDTA salts, methylparaben, propyl parabens, benzoic acid or a salt thereof, ethanol, isopropyl alcohol, benzyl alcohol, sorbates, urea derivatives, isothiazolinone, and mixtures thereof.

The preservative is preferably present in an amount about 0.01 wt % to about 0.5 wt % of the total weight of the composition.

It is still another embodiment of the present composition to also include a solvent, in addition to water, to anyone of the above embodiments. The solvent is preferably an alcohol, such as ethyl or isopropyl alcohol; propylene glycol; dipropylene glycol; or mixtures thereof.

The solvent is preferably up to about 25 wt % of the total weight of the composition. More preferably, the solvent is about 5 wt % to about 15 wt % of the total weight of the composition.

Each embodiment of the present invention can also further include an odor absorber and/or colors and/or enzymes.

The colors can be any colors that a re approved safe for application to the hair. The color is preferably present in an amount about 0.0005 wt % to about 0.005 wt % of the total weight of the composition.

The preferred enzymes are disclosed in U.S. Pat. Nos. 5,547,665 and 5,968,507 both by inventor Harry F. Upton. The enzymes are preferably present in an amount determined by their enzymatic activity. These activities are generally expressed as units relating to their ability to liberate individual components of the particular substrate, e.g. carbohydrate, protein and lipid. While no single basis, e.g. wt %, can be generalized for all enzyme systems, the enzymatic activity for each enzyme would be recognized as significant by those skilled in the art.

In one embodiment of the present nit removing composition, the surfactant is an anionic surfactant, preferably a sulfonate or sulfate, and more preferably it is sodium dodecylbenzene sulfonate. Also, it is present in an amount about 0.05 wt % to about 2 wt % of the total weight of the composition. In a second embodiment, the composition further includes about 0.2 wt % to about 6 wt % of an organic acid, about 0.1 wt % to about 1 wt % of a thickener, and up to about 15 wt % of alcohol.

The present composition can be in any liquid form. Preferably, the composition is in the form of a low-viscosity liquid, preferably from about 5 cps. to about 300 cps. (a thin gel).

This invention will be better understood from the following experiments. These experiments and the test protocol are the subject of co-pending application entitled “Screening Protocol For Nit Loosening” filed on even date to the same inventors as the present invention, which is incorporated by reference.

A. One thin gel was made that included the anionic surfactant of the present invention, namely DDBSA (i.e. the sodium salt of dodecyl benzene sulfonic acid) in an amount 0.1 wt %, and a nonionic surfactant, namely Tergitol in the amount 5 wt %. The gel was applied to a hair shaft. The nit glue broke up in about thirty seconds. Pieces of the glue floated away and lifted off the shaft. Within five minutes, most of the sheath was disrupted. The solution was augmented several times due to solvent evaporation.

B. A non-thickened composition of A was made, but with 5% acetic acid added. The solution was applied to a hair shaft. Within one minute, larger gel-like glue particles broke off the sheath. Some opacifying took place.

C. A test was performed using the presently commercial RID® shampoo. It has pyrethrum extract and piperonyl butoxide as its principal ingredients. It was initially applied for ten minutes to a hair shaft, then washed off. No significant change occurred. Then the gel of A was applied. Some fragments of sheath appeared to dislodge after one minute, and some swelling took place over the next twelve minutes, but no further change thereafter.

D. The RID® shampoo was initially applied for ten minutes to a hair shaft, then washed off. No significant change occurred. Then the composition of B was applied to a hair shaft, the glue of the nit sheath softened, but there was no break-off of particles.

E. A formula having 0.1% DDBSA was applied to a hair shaft, but only after the hair shaft had the RID® Shampoo thereon for ten minutes. After the RID® shampoo was on the hair shaft for ten minutes, there was a small tear at the end of the glue sheath. After DDBSA was applied, the sheath swelled. Pieces of the sheath broke off within one minute. This continued with the sheath portion slowly opacifying in spots. After ten minutes, the nit could be readily displaced from the hair shaft using a needle probe.

F. The presently commercial Care Lice Killing Shampoo (standard LKS) was applied to a hair shaft for ten minutes, and then washed off. The Shampoo has pyrethrum extract and piperonyl butoxide as its principal ingredients. Thereafter, Care LKS containing 0.2% DDBSA (spiked LKS) was applied. There was no obvious effect after the standard LKS, washing and observing under scope. The spiked LKS caused swelling/gelling of the sheath in one to two minutes.

G. Spiked LKS, namely Care Lice Killing shampoo with 0.2% DDBSA added, was applied to a hair shaft. In thirty seconds, the glue material swelled, particles floated freely, and the sheath gradually lost particles of the gelled glue attached along its length. Thus, this was very effective.

H. The presently commercial Care Lice Egg Remover with 0.1 wt % DDBSA added was prepared and applied to a hair shaft. The Egg Remover has a variety of mixed aqueous enzymes as its principal ingredients. Inside of one minute, particles were observed floating off the sheath. This was dramatic.

I. The Care Lice Egg Remover was prepared with 4% Tergitol, and applied to a hair shaft. Swelling occurred in one to two minutes, and there were few “floaters”. After five minutes, there was swelling with small particle dislodgment. This did not perform as well as H.

J. Gel I with 5% acetic acid was applied to a hair shaft. There was some swelling though nothing significant.

K. DDBSA with 20% isopropyl alcohol was formed and applied on a hair shaft. Dramatic disruption of sheath particles during the seven minutes of observation. A repeated run showed gelation and some pieces breaking off in about one minute, but not as dramatic as the first run. The effect seems to increase after some alcohol evaporates. However, 20% alcohol may have too strong an odor for a commercial product.

It was also found that 0.2% DDBSA applied to a hair shaft caused bubbling under surface of sheath, gradually fusing. The nit slid off easily with a needle probe after ten minutes of exposure. It was also found that when 5% DDBSA was applied to a hair shaft, there was the same general experience as with 0.1% and 0.2% DDBSA, namely easy slide off.

Thus, the above experiments show the unexpected results primarily based on the presence of an anionic surfactant.

The present invention also includes methods for loosening or removing nits from the hair. One method includes applying a surfactant-based composition to the hair. The surfactant has the capability to attack the lipids of the nits and, preferably, is anionic in all of the following methods. Another method for removing nits from hair according to the present invention includes: applying a pediculicide and a surfactant-based composition to the hair; removing the pediculicide and the surfactant-based composition from the hair after a substantial portion of the nits are killed; and removing the dislodged nits.

Another method for removing nits from hair according to the present invention includes: applying a pediculicide to the hair; removing the pediculicide from the hair after a substantial portion of the nits are killed; applying a surfactant-based composition to the hair; removing the dislodged nits; and removing the surfactant-based composition from said hair.

Still another method for removing nits from hair according to the present invention includes: applying a surfactant-based composition to the hair; removing the surfactant-based composition from said hair; applying a pediculicide to the hair; removing the pediculicide from the hair after a substantial portion of the nits are killed; and removing the dislodged nits from the host.

However, one skilled in the art will readily appreciate that the specific methods and results discussed are merely illustrative of the present invention as described more fully in the claims, which follow hereafter.

What is claimed is:

1. A method for removing nits from hair, which comprises applying a surfactant-based composition to the hair, whereby said surfactant-based composition is capable of attacking lipids of the nits.

2. The method of claim 1, wherein said surfactant-based composition includes an anionic surfactant.

3. A method for removing nits from hair which comprises the steps of:
applying a pediculicide and subsequently a surfactant-based composition to the hair;
removing the pediculicide and the surfactant-based composition from the hair after a substantial portion of the nits are killed; and
removing the dislodged nits.

4. A method for removing nits from hair comprising the steps of:
applying a pediculicide to the hair;
removing the pediculicide from the hair after a substantial portion of the nits are killed;
applying a surfactant-based composition to the hair, capable of attacking the lipids in the nits;
removing the dislodged nits; and
removing the surfactant-based composition from said hair.

5. A method for removing nits from hair comprising the steps of:
applying a surfactant-based composition to the hair, wherein said surfactant-based composition is capable of attacking the lipids in the nits;
removing the surfactant-based enzyme composition from the hair;
applying a pediculicide to the hair;
removing the pediculicide from the hair after a substantial portion of the nits are killed; and
removing the dislodged nits from the hair.

6. A nit removing composition comprising a surfactant that attacks lipids in the nits.

7. The nit removing composition of claim 6, wherein said surfactant is an anionic surfactant.

8. The nit removing composition of claim 7, wherein said anionic surfactant is a sulfonate or a sulfate.

9. The nit removing composition of claim 8, wherein said sulfate is selected from a group consisting of ethoxylated alkylphenol sulfates, sulfates of oil and fatty acids, alcohol sulfates, sulfates of ethoxylated alcohols, sulfates of fatty esters, and mixtures thereof.

10. The nit removing composition of claim 7, wherein said anionic surfactant is a lipophilic anionic surfactant.

11. The nit removing composition of claim 7, wherein said anionic surfactant is a dodecylbenzene sulfonate.

12. The nit removing composition of claim 6, further comprising an acid.

13. The nit removing composition of claim 12, wherein said acid is a C₁-C₄ carbon acid or a hydroxy substituted derivative thereof.

14. The nit removing composition of claim 12, wherein said acid is an organic acid.

15. The nit removing composition of claim 14, wherein said organic acid is selected from a group consisting of lactic acid, glycolic acid, acetic acid, and mixtures thereof.

16. The nit removing composition of claim 6, further comprising a thickener.

17. The nit removing composition of claim 16, wherein the thickener is selected from a group consisting of xanthan gum, methyl cellulose, hydroxypropyl cellulose, hydroxyethyl cellulose, carbopol, gum acacia, Sepigel 305, Vee-Gum, magnesium aluminum silicate, polyoxyethylene, polyacrylamide and derivatives thereof, and mixtures thereof.

18. The nit removing composition of claim 6, further comprising a preservative.

19. The nit removing composition of claim 18, wherein the preservative is selected from a group consisting of disodium EDTA, EDTA salts, methylparaben, propyl parabens, benzoic acid or a salt thereof, ethanol, isopropyl alcohol, benzyl alcohol, sorbates, urea derivatives, isothiazolinone, and mixtures thereof.

20. The nit removing composition of claim 6, further comprising a solvent.

21. The nit removing composition of claim 20, wherein said solvent is selected from the group consisting of alcohol, propylene glycol, dipropylene glycol, and mixtures thereof.

22. The nit removing composition of claim 6, wherein the composition further comprises about 0.2 wt % to about 6 wt % of an organic acid, about 0.1 wt % to about 1 wt % of a thickening composition, and up to about 15 wt % of alcohol.

23. The nit removing composition of claim 6, wherein said surfactant is about 0.05 wt % to about 5 wt % of the total weight of the composition.

24. The nit removing composition of claim 6, wherein said surfactant is about 0.05 wt % to about 2 wt % of the total weight of the composition.

25. The nit removing composition of claim 6, wherein said surfactant is about 0.2 wt % to about 1 wt % of the total weight of the composition.

26. The nit removing composition of claim 6, further comprising an alcohol in an amount up to about 15 wt % of the total weight of the composition.

27. The nit removing composition of claim 26, wherein said alcohol is about 5 wt % to about 15 wt % of the total weight of the composition.

28. The nit removing composition of claim 6, further comprising an enzyme.
